(19) United States
(12) Patent Application Publication
(10) Pub. No.: US 2012/0305272 A1
(43) Pub. Date: Dec. 6, 2012

(54) FOAM GENERATING DEVICE FOR FIRE HOSES

(75) Inventor: Bruno GRANDPIERRE, Nogent Sur Seine (FR)

(73) Assignee: POK S.A., Nogent Sur Seine Cedex (FR)

(21) Appl. No.: 13/470,950

(22) Filed: May 14, 2012

(30) Foreign Application Priority Data
Jun. 6, 2011 (FR) 11/54886

(51) Int. Cl. A62C 35/00

(52) U.S. Cl. 169/14

(57) ABSTRACT

A foam generating device for a fire hose, comprising a socket designed to be attached to a water supply hose, a hose nozzle consisting of a first end wherein air inlets are made and of a second end for spraying the foam, an intermediate body attached between the socket and the first end of the hose nozzle and allowing the creation of several separate water jets passing through. The intermediate body is so arranged as to receive an emulsifying fluid and to pre-mix it with the water jets by aspiration and by contact of the emulsifying fluid with the water jets, then to spray the jets of water-emulsifier premix and to stir them with the air streams in the hose nozzle.

The present invention applies to the field of fire hoses.

It applies more particularly to a foam generating device for a fire hose.

These foam generating devices are designed so as to avoid inadequate and non-uniform expansion of the foam-emulsifier premix with air during formation of the foam sprayed through the tip of the hose nozzle, the expansion corresponding to the ratio of the volume of the generated foam to the volume of foam-generating solution used.

Indeed, inadequacy and non-uniformity of expansion can limit the effectiveness of the foam in smothering the fire and the range of the foam jet.

Such a foam generating device is known from the prior art in European patent application EP 2 186 545.

This foam generating device exhibits a hose nozzle consisting of a cylindrical or slightly convergent downstream tube having a first end wherein air inlets are provided and a second end through which the foam emerges, an upstream cylindrical tube placed coaxially within the downstream tube and a first end of the hose nozzle and a divergent cone arranged coaxially within the upstream cylindrical tube.

The divergent cone is provided with corrugations, the propagation front of the initial premix of water and emulsifier traveling within the cylindrical upstream tube around the corrugated divergent cone to create, at the outlet of this upstream tube, divergent water-emulsifier premix jets that are separated from the initial premix made up of the water and the emulsifier.

The separation of the jets of water-emulsifier premix makes it possible to create an aspiration effect drawing outside air into the upstream tube of the hose nozzle and mixing of the aspirated air streams and the air-emulsifier premix jets in the jet separation zones.

Thus, by this separation of the premix jets, the foam generating device described in European patent application EP 2 186 545 makes possible the creation of a final mixture of jets of foam having satisfactory expansion values and in satisfactory quantity.

However, additional equipment is necessary for using this foam generating device in order to make the water-emulsifier premix used in the foam generating device.

Such additional equipment is currently known, such as for example electronic devices for injecting emulsifier into the water.

The present invention has as its object to correct this principal disadvantage of the prior art and to propose a foam generating device for a fire hose including a socket designed to be attached to a water supply hose, a hose nozzle consisting of a first end wherein the air inlets are made and a second foam spraying end and an intermediate ring attached between the socket and the first end of the hose nozzle and allowing the creation of several separate water jets running through it.

The foam generating device is noteworthy in that the intermediate body is arranged so as to receive an emulsifying fluid and to pre-mix it with the water jets by aspiration and by contact of the emulsifying fluid with the water jets, then to spray the water-emulsifier premix jets and to stir them together with the air streams in the hose nozzle.

Thanks to the invention, the intermediate body makes it possible to avoid having to use additional water and emulsifier premixing equipment and to obtain foam having the qualities required for fighting fires.

The intermediate body has an intermediate body having a chamber for injecting the separate water jets and sucking the emulsifier into the water jets, the water jets being arranged in a ring upstream the air inlets.

Thus, the foam generating device according to the invention makes it possible to advantageously combine the advantages of automatic aspiration of the emulsifier at the chamber and the quality of stirring of the convergent jets of water-emulsifier premix with the air streams by aspiration in the hose nozzle.

Advantageously, the injection and aspiration chamber has a volume bounded by: a substantially cylindrical axial wall having an opening designed to receive an emulsifier supply means, a first radial wall having first and second openings designed to communicate with the socket, and a second radial wall having second openings designed to communicate with the hose nozzle, each second opening being located facing a first opening, the first openings and the second openings being arranged in a ring in the radial walls.

The first radial wall of the intermediate body has a divergent cone in relief allowing the water stream to be divided, the first openings being arranged in a ring on the periphery of and around the divergent cone in the first radial wall.

Advantageously, the intermediate body has a first substantially cylindrical axial end wall allowing its attachment to the socket and a second substantially cylindrical end wall allowing its attachment to the hose nozzle.

Advantageously, the intermediate body has several means for guiding and accelerating the water jets housed in the first openings and opening into the injection and aspiration chamber, these guiding and accelerating means allowing, upon their emergence into the injection and aspiration chamber, the entrainment of the emulsifier into the water jets, by aspiration and by contact of the emulsifier with the water jets.

Due to the very high speeds of the water jets thanks to these water jet accelerating and guiding means, the injection and aspiration chamber makes it possible to create a pressure drop which brings about the automatic aspiration of the emulsifier into the water jets.

In the embodiment of the invention, the guiding and accelerating means are first tubes having a portion with a convergent cross-section allowing acceleration of the water jet flow so as to aspirate the emulsifier at their exit.

In this particular case, the first tubes are injectors that have a portion with a convergent truncated cross-section followed by a portion with a straight cross-section.

Advantageously, the intermediate body has several means for guiding and pre-mixing the emulsifier into the water jets, these guiding and pre-mixing means being housed in the second openings and opening into the injection and aspiration chamber.

In the embodiment of the invention, the guiding and pre-mixing means are second tubes, the flow cross-section whereof allows premixing of the emulsifier with each water jet received by a tube.

Preferably, the second tubes have a straight cross-section.

Advantageously, the second tubes have a length greater than the first end of the hose nozzle and allow the water-emulsifier premix jets to emerge downstream of the air inlets, once the tubes are inserted in the second openings.

The invention, its features and advantages will appear more clearly upon reading the description made with reference to the appended figures wherein:

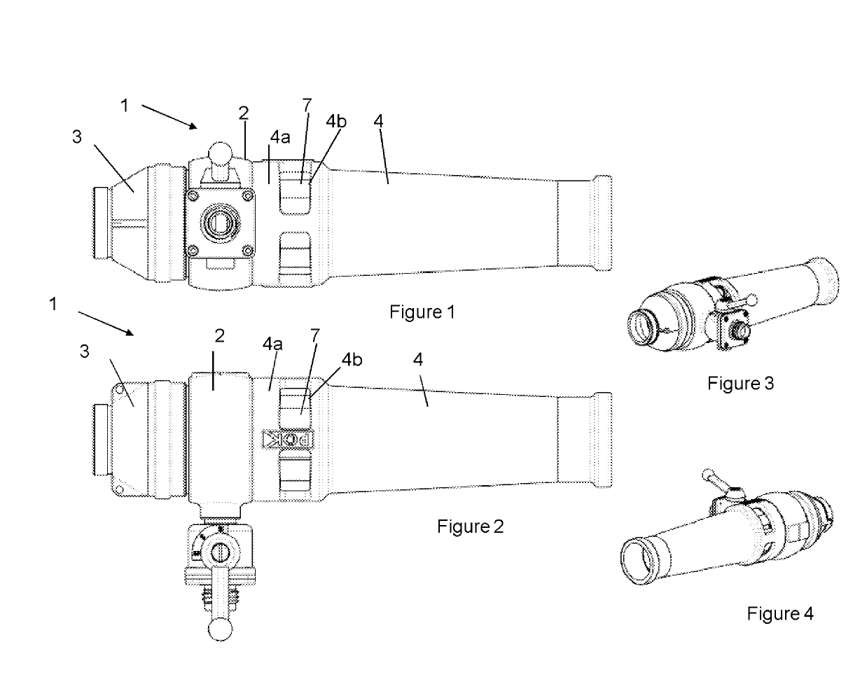

FIGS. 1 through 4 show perspective views of the foam generating device according to the invention;

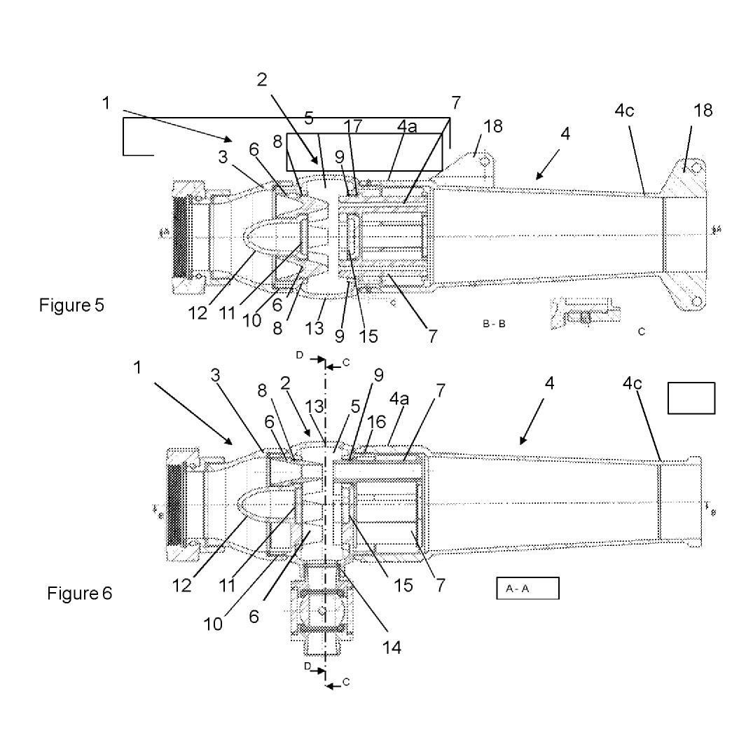

FIG. 5 shows a section view of the foam generating device at section line B-B shown in FIG. 6;

FIG. 6 shows a section view of the foam generating device at section line A-A shown in FIG. 5;

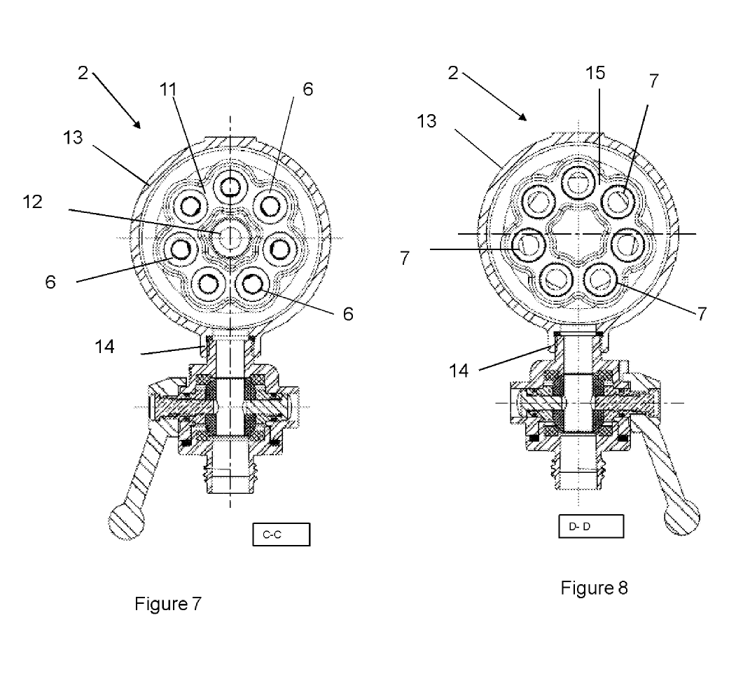

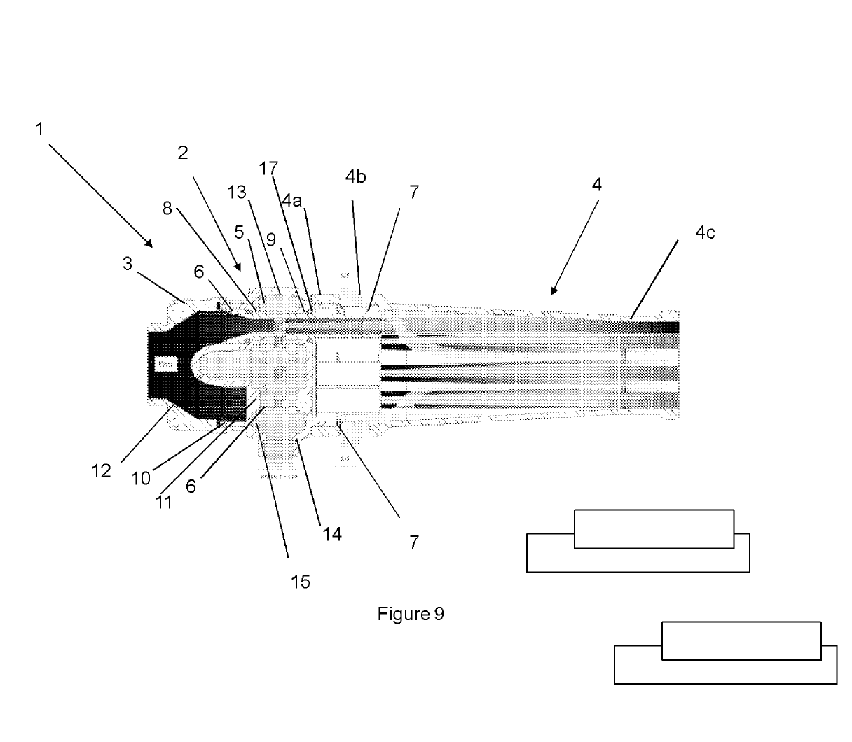

FIG. 7 shows a section view of the ring of the foam generating device at section line C-C shown in FIG. 6;

FIG. 8 shows a section view of the ring of the foam generating device at section line D-D shown in FIG. 6;

FIG. 9 shows a view of the foam generating device illustrating its operation, the device having water jets, water-emulsifier premix jets and air streams flowing through it.

The set of FIGS. 1 though 9 describes a foam generating system (1) for a fire hose having an intermediate body (2) which makes it possible, in conformity with the invention, to achieve entrainment of an emulsifying fluid into separate jets of water and stirring of the air streams into each of the water-emulsifier premix jets so as to produce an extinguishing foam.

The term “axial” used hereafter in the description describes any element extending parallel to the longitudinal axis of the foam generating device (1), the term “radial” any element extending perpendicularly to the longitudinal axis of the foam generating device (1), and the terms “upstream” and “downstream” relating to the orientation of the fluid flow which occurs in an axial direction from left to right in FIGS. 1, 2, 3, 5, 6 and 9.

The intermediate body (2) having a substantially cylindrical shape is located between a downstream end of a socket (3) and the first upstream end of a hose nozzle (4).

The socket (3) is an inlet nozzle and is attached by a threaded connection at its upstream end to a water supply hose.

The hose nozzle (4) is known and is advantageously that described in European patent EP 2 168 545.

It has a substantially truncated body (4) convergent toward the outlet end (4c) of the hose nozzle (4).

The body (4) includes at its first, upstream end (4a) some air inlets (4b) and at its second, downstream end (4c) a convergent truncated wall against which the jets of water-emulsifier premix and the air streams mix together to form the extinguishing foam.

The intermediate body (2) according to the invention is arranged so as to create separate jets of water that run axially through it and to pre-mix the emulsifying fluid with the separate water jets by aspiration and by contact of the emulsifying fluid with the water jets, the emulsifying fluid being spread around each water jet.

Thereafter, the water-emulsifier premix jets are stirred with the air streams in the hose nozzle (4), the air streams surrounding the water-emulsifier premix jets over their entire perimeter as they leave the intermediate body (2) in the hose nozzle (4), which allows the production of foam with an expansion value having remarkable properties.

More precisely, the intermediate body (2) has an injection and aspiration chamber (5) having a volume so arranged as to allow the injection of a ring of separate water jets and the aspiration of the emulsifier into the water jets.

In the embodiment shown, means (6) for guiding and accelerating the flow of the water jets communicate with the chamber (5).

They open upstream into the socket (3) and downstream into the chamber (5). They make it possible to guide and accelerate the water jets and then to accomplish the entrainment of the emulsifying fluid with the water jets by aspiration and by contact of the emulsifying fluid with the water jets at their emergence into the aspiration chamber (5).

The means (6) for guiding and accelerating the water jets exhibit water jet channels having an axial shrinkage of their cross-section to accomplish at their outlets the aspiration of the emulsifier into the water jets by venturi effect due to the acceleration of the water jets.

As illustrated in the figures, the guiding and accelerating means (6) are tubes called “first tubes” which open into the socket (3) by an upstream end and by a downstream end into the injection and aspiration chamber (5).

Here in this particular case, these are injectors or “eductors” which have a first portion having a convergent cross-section, the inlet whereof opens into the socket (3), this first portion being followed by a second portion having a straight cross-section the outlet whereof opens into the injection and aspiration chamber (5).

They are placed in first openings (8) or “upstream openings” of the intermediate body (2), these first openings (8) being arranged in a ring, which is illustrated in particular in FIG. 7.

They are attached to the intermediate body (2), with a threaded connection for example.

Advantageously, the first openings (8) are regularly spaced around the ring.

Means (7) for guiding and pre-mixing of the water-emulsifier jets aligned with the guiding and accelerating means (6) open upstream into the chamber (5) and downstream into the hose nozzle (4).

The guiding and pre-mixing means (7) have water-emulsifier jet channels having a length that allows the emulsifier to be mixed with the water jets and the water-emulsifier jets to be kept separate from one another.

Here in this particular case, these guiding and pre-mixing means are tubes (7) called “second tubes” or channels opening at an upstream end into the injection and aspiration chamber (5) and by a downstream end into the hose nozzle (4).

They are located within the intermediate body (2) to allow the envelopment over their entire outside surface of the water-emulsifier jets by the streams of aspirated air as they leave the tube.

In this instance, the second tubes (7) are arranged within the second openings (9) or “downstream openings” of the intermediate body (2), these second openings (9) being arranged in a ring facing or opposite the first openings (8), as illustrated in FIGS. 5, 6, 8 and 9.

They are attached to the intermediate body (2), by a threaded connection for example.

Advantageously, the second openings (9) are regularly spaced over the ring.

The second tubes (7) have such a length that once assembled in the second openings (9), their downstream end is located at or downstream of the air inlets (4b) of the hose nozzle (4).

Here, these are tubes (7) with straight sections, but they could have any type of section for the channel through which pass the water-emulsifier jets, for example a divergent truncated section.

The first tubes (6) and the second tubes (7) are arranged face-to-face in the premixing chamber (5) due to the face-to-face positioning of the first openings (8) and the second openings (9).

A space is provided between the downstream ends of the first tubes (6) and the upstream ends of the second tubes (7) opening into the injection and aspiration chamber (5) to allow the emergence of the water jets from the first tubes (6) into the chamber (5) and the entry into the second tubes (7) of the water jets entraining the emulsifier by aspiration and contact.

As illustrated in particular in FIGS. 5, 6 and 9, the intermediate body (2) has an upstream portion oriented in the foam generating device (1) toward the socket (3) and allowing the generation of water jets, a central portion allowing the aspiration and injection of a quantity of emulsifying fluid into each water jet, and a downstream portion oriented in the foam generating device (1) toward the hose nozzle (4) and making possible the mixing of the emulsifying fluid and the water jets.

The upstream portion includes a substantially cylindrical longitudinal axial wall (10) inserted and attached to the inside of the socket (3), a first upstream radial wall (11), having the first openings (8) located on its periphery and surrounding an element in relief (12) having substantially the shape of a divergent cone.

This element in relief (12) is centered on the first radial wall (11). It allows the division of the water stream within the socket (3) while limiting the turbulence in these water jets, the water being subsequently further divided into water jets in the first tubes (6).

The central portion consists of a hollow body constituting the chamber (5) for injection and aspiration between the water jets and the emulsifying fluid, the hollow body being connected and communicating on the one hand with the socket (3) and with the hose (4) and on the other hand radially with an emulsifying fluid supply means equipped with an opening valve.

More precisely, the hollow body consists, on the one hand, of a substantially cylindrical central axial longitudinal wall (13) having a radial opening (14) to which is connected the emulsifier supply means, and on the other hand, by the first, upstream radial wall (11) and by a second, downstream radial wall (15), these radial walls (11, 15) being parallel and substantially circular and extending perpendicularly to the longitudinal axial wall (13) so as to form the volume of the injection and aspiration chamber (5).

The downstream portion of the intermediate body (2) includes the second, downstream radial wall (15) and a substantially cylindrical longitudinal axial wall (16) inserted and attached inside the first, upstream end of the hose nozzle (4).

The second radial wall (15) has second openings (9) which are located facing the first openings (8), these second openings (9) having the second, downstream water and emulsifier premixing tubes (7) passing through them.

The number of the first openings (8) and of the second openings (9) is not fixed and depends on the dimensions of the first radial wall (11) and of the second radial wall (15).

Solely by way of example, seven openings (8) and (9) are shown in FIG. 7.

O-rings (17) ensure the fluid-tightness of the device and are arranged between a shoulder in the first tubes (6) and the outer face of the first, upstream radial wall (11) and a shoulder of the second tubes (7) and the outer face of the second, downstream radial wall (15).

In a variation of implementation, advantageously but without limitation, the hose nozzle (4) has, on its outer axial wall, spurs (18) allowing attachment of plates for spraying the foam according to a particular form of hose nozzle (4) outlet spout, as illustrated in FIG. 5.

During operation of the foam generating device (1), the intermediate injection and aspiration chamber (5) fills with emulsifier and the quantity of emulsifier is aspirated by each second, downstream tube (7), which allows substantially homogeneous premixing of the water-emulsifier jets in each second, downstream tube (7).

Thus, thanks to this intermediate body (2) used advantageously in conjunction with means (6) for guiding and accelerating water jets and means (7) for guiding and premixing water-emulsifier jets, the foam generating device according to the invention makes it possible to obtain, while still using automatic aspiration of the emulsifier (that is without having to use additional equipment to carry out water-emulsifier mixing), foams particularly having low expansions, by aspiration of the air streams at the first, upstream end of the hose nozzle (4) around the ring of separate water-emulsifier jets.

For example, by way of illustration and without limitation, the expansion values can be comprised between 10 and 28 depending on the emulsifier used.

Moreover, the foam generating device according to the invention makes it possible to obtain increases in range of from 10 to 20% compared with known devices.

It should be obvious to persons well-versed in the art that the present invention allows embodiments in many other specific forms without departing from the field of application of the invention as claimed. Consequently, the present embodiments should be considered to be by way of illustration but can be modified within the field defined by the scope of the appended claims.

1. A foam generating device for a fire hose, comprising:
a socket designed to be attached to a water supply hose;
a hose nozzle consisting of a first end wherein air inlets are made and of a second end for spraying the foam; and
an intermediate body attached between the socket and the first end of the hose nozzle and allowing the creation of several separate water jets passing through,
wherein the intermediate body has a chamber for injection of the water jets and aspiration of an emulsifier into the water jets, the intermediate body being arranged to receive the emulsifying fluid and to pre-mix the emulsifying fluid with the water jets by aspiration and by contact of the emulsifying fluid with the water jets, then to spray the water-emulsifier premix jets and to stir them with the air streams in hose nozzle.

2. The foam generating device according to claim 1, wherein the water jets created by the intermediate body are arranged in a ring upstream of the air inlets.

3. The foam generating device according to claim 2, wherein the injection and aspiration chamber has a volume bounded by: a first radial wall having first openings designed to communicate with the socket, a longitudinal axial wall having an opening designed to receive an emulsifier supply means, and a second radial wall having second openings designed to communicate with the hose nozzle, each second opening being located facing a first opening, the first openings and the second openings being arranged in a ring in the radial walls.

4. The foam generating device according to claim 3, wherein the first radial wall has axially, in relief, a divergent cone allowing the water stream to be divided and in that the first openings are regularly spaced in a ring at the periphery of and around the divergent cone in the first radial wall.

5. The foam generating device according to claim 3, wherein the intermediate body has several means for guiding and accelerating the water jets housed in the first openings and opening into the injection and aspiration chamber, these the guiding and accelerating means for allowing, at their exit into the injection and aspiration chamber, the entrainment of the emulsifier into the water jets, by aspiration and by contact of the emulsifier with the water jets.

6. The foam generating device according to claim 3, wherein the intermediate body has several means for guiding and pre-mixing the emulsifier into the water jets, the guiding and premixing means being housed in the second openings and opening into the injection and aspiration chamber.

7. The foam generating device according to claim 4, wherein the guiding and acceleration means are first tubes having a portion having a convergent cross-section for allowing acceleration of the flow of the water jets so as to aspirate emulsifier at their exit.

8. The foam generating device according to claim 7, wherein the guiding and premixing means are second tubes, the flow section whereof allows premixing of the emulsifier with each water jet received by a tube.

9. The foam generating device according to claim 8, wherein the first tubes have a length greater than the length of the first end of the hose nozzle and are configured to allow allowing the jets of water-emulsifier premix to emerge downstream of the air inlets, after the first tubes are housed in the second openings.

10. The foam generating device according to claim 7, wherein the first tubes are injectors that have a portion with a convergent truncated cross-section followed by a portion with a straight cross-section.

11. The foam generating device according to claim 9, wherein the second tubes are tubes having straight cross-sections.

12. The foam generating device according to claim 1, wherein the intermediate body has a substantially cylindrical axial longitudinal wall, a first longitudinal axial I with a substantially cylindrical end configured to be attached to the socket and a second longitudinal axial wall with a substantially cylindrical end configured to be attached to the hose nozzle.
